(19) United States
(12) Patent Application Publication
(10) Pub. No.: US 2016/0205728 A1
(43) Pub. Date: Jul. 14, 2016

(54) MICROWAVE APPLIANCES

(71) Applicant: General Electric Company, Schenectady, NY (US)

(72) Inventor: Seog-Tae Kim, Prospect, KY (US)

(21) Appl. No.: 14/595,278

(22) Filed: Jan. 13, 2015

(51) Int. Cl. H05B 6/64; F24C 1/00

(52) U.S. Cl. CPC H05B 6/6402; F24C 1/00

(57) ABSTRACT

Microwave appliances are provided. A microwave appliance includes a casing defining a first interior chamber and a second interior chamber. The microwave appliance further includes an electromagnetic radiation source coupled to the first interior chamber and operable to provide microwave radiation to the first interior chamber, and a heating element disposed within the second interior chamber and operable to heat the second interior chamber.

### FIELD OF THE INVENTION

The present disclosure relates generally to microwave appliances, and more particularly to microwave appliance which include microwave chambers and separate thermal heating chambers.

### BACKGROUND OF THE INVENTION

Microwave appliances are generally known in the art for producing microwave radiation to heat, for example, food and beverage items. Some microwave appliances, known conventionally as over-the-range microwave appliances, can be mounted above the cooktop of an oven range appliance. Other microwave appliances are, for example, simply set on the countertop.

While microwave appliances are generally considered to be a convenient apparatus with which to heat food and beverage items, they do have some disadvantages. For example, many types of cooking, such as broiling and baking, cannot be performed using microwave radiation. Users may instead be forced to, for example, use the oven to perform such types of cooking This can be relatively inefficient in many cases when cooking of relatively small items is desired, due to the requirement to heat the relatively large cavity of the oven.

Accordingly, improved microwave appliances are desired in the art. In particular, microwave appliances which provide multiple cooking options would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a microwave appliance is provided. The microwave appliance includes a casing defining a first interior chamber and a second interior chamber. The microwave appliance further includes an electromagnetic radiation source coupled to the first interior chamber and operable to provide microwave radiation to the first interior chamber, and a heating element disposed within the second interior chamber and operable to heat the second interior chamber.

In accordance with one embodiment of the present disclosure, a microwave appliance is provided. The microwave appliance defines a vertical direction, a lateral direction, and a transverse direction which are mutually orthogonal. The microwave appliance includes a casing defining a first interior chamber and a second interior chamber, and an outer housing generally surrounding the casing and defining a passage therebetween. The microwave appliance further includes an electromagnetic radiation source coupled to the first interior chamber and operable to provide microwave radiation to the first interior chamber, the electromagnetic radiation source disposed within the passage and spaced from the first interior chamber and the second interior chamber along the vertical direction. The microwave appliance further includes a heating element disposed within the second interior chamber and operable to heat the second interior chamber. The microwave appliance further includes a first door rotatable about a first rotational axis to provide selective access to the first interior chamber, and a second door rotatable about a second rotational axis to provide selective access to the second interior chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a front view of a microwave appliance in accordance with one embodiment of the present disclosure;

FIG. 2 is a perspective view of a microwave appliance, with a second door shown in an open position and various components removed from a second interior chamber for illustrative purposes, in accordance with one embodiment of the present disclosure;

FIG. 3 is a perspective view of a microwave appliance, with a second door shown in an open position and various components removed from a second interior chamber for illustrative purposes, in accordance with another embodiment of the present disclosure;

FIG. 4 is a perspective view of a microwave appliance with an outer housing removed for illustrative purposes in accordance with one embodiment of the present disclosure;

FIG. 5 is a front cross-sectional schematic view of a microwave appliance in accordance with one embodiment of the present disclosure; and

FIG. 6 is a perspective view of the portion of a casing of a microwave appliance which defines a second interior chamber in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

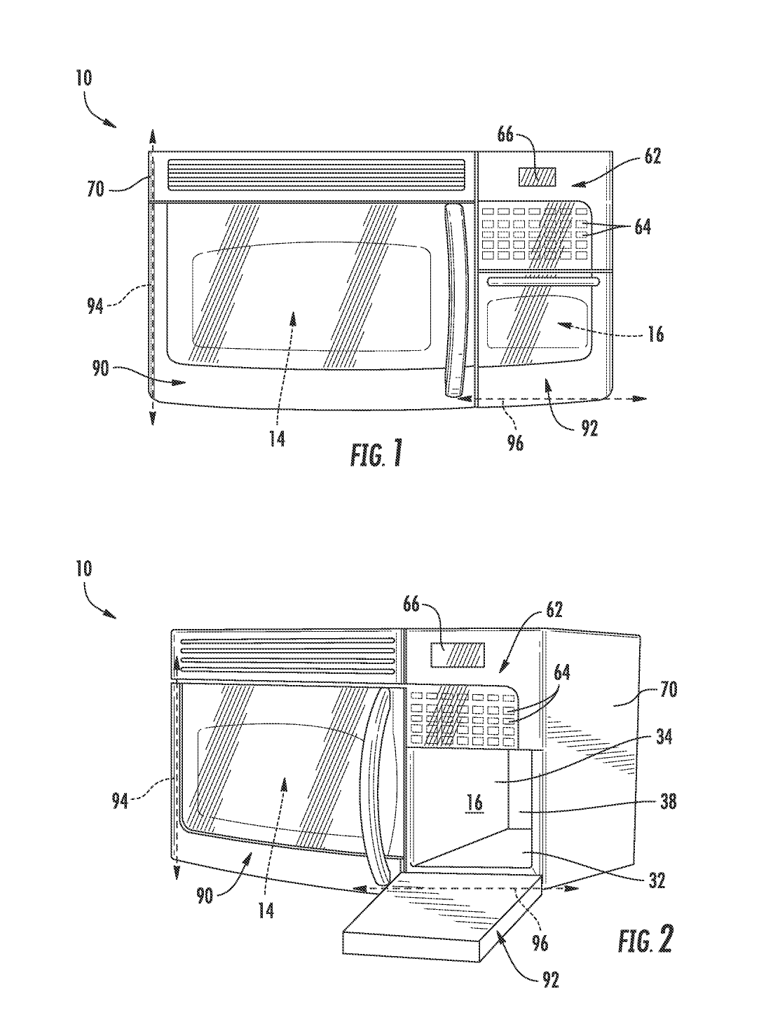

Referring to FIGS. 1 through 5, a microwave appliance 10 in accordance with embodiments of the present disclosure is provided. Additionally, FIG. 6 illustrates a portion of microwave appliance 10, as discussed herein. Microwave appliance 10 generally defines a coordinate system which includes a vertical direction V, a lateral direction L, and a transverse direction V, which are mutually orthogonal as illustrated. As discussed herein, microwave appliance 10 advantageously includes a chamber configured for microwave functions, and to which microwave radiation is thus provided, and a chamber configured for thermal heating functions, and to which thermal heat from one or more heating elements is provided.

Referring to FIGS. 4 through 6, microwave appliance 10 includes a casing 12 which defines a first interior chamber 14 and a second interior chamber 16. The casing 12 can be a single integrally formed component, or can include one or more components that are connected together. Casing 12 may, for example, be formed from a suitable metal, plastic, or combination thereof.

Various surfaces of the casing 12 may define the interior chambers 14, 16. For example, the first interior chamber 14 may be defined by and between a top surface 20, bottom surface 22, side surfaces 24 and 26, and a rear surface 28. The top and bottom surfaces 20, 22 may be spaced from each other along the vertical direction. The side surfaces 24, 26 may be spaced from each other along the lateral direction L. The rear surface 28 may be spaced from a front opening 29 of interior chamber 14 along the transverse direction T. The second interior chamber 16 may be defined by and between a top surface 30, bottom surface 32, side surfaces 34 and 36, and a rear surface 38. The top and bottom surfaces 30, 32 may be spaced from each other along the vertical direction. The side surfaces 34, 36 may be spaced from each other along the lateral direction L. The rear surface 38 may be spaced from a front opening 39 of interior chamber 16 along the transverse direction T.

Further, in exemplary embodiments as illustrated, the second interior chamber 16 may be spaced from the first interior chamber 14 along the lateral direction L. Alternatively, however, any suitable positioning and arrangement of the chambers 14, 16 is within the scope and spirit of the present disclosure.

As discussed, microwave appliance 10 includes a chamber configured for microwave functions. Accordingly, first interior chamber 14 may be so configured. For example, microwave appliance 10 may further include an electromagnetic radiation source 40 that is coupled to the first interior chamber 14 and operable to provide microwave radiation to the first interior chamber 14.

Electromagnetic radiation source 40 may, for example, include a magnetron 42 (such as, for example, a cavity magnetron), a high voltage transformer 44, a high voltage capacitor 46 and a high voltage diode 48. The transformer 44 may provide energy from a suitable energy source (such as an electrical outlet) to the magnetron 42. The magnetron 42 may convert the energy to electromagnetic radiation, specifically microwave radiation. The capacitor 46 generally connects the magnetron 42 and transformer 44, such as via high voltage diode 48, to a chassis such as the casing 12. Microwave radiation produced by the magnetron 42 and the electromagnetic radiation source 40 may be transmitted through a waveguide 49 to the first interior chamber 14.

It should be noted that microwave radiation as utilized herein and as generally understood is a form of electromagnetic radiation having wavelengths ranging between approximately one millimeter and approximately one meter and/or frequencies ranging between approximately 300 Megahertz and approximately 300 Gigahertz. In some embodiments, microwave radiation as utilized herein may have wavelengths ranging between approximately three millimeters and approximately 300 millimeters and/or frequencies ranging between approximately one Gigahertz and approximately 100 Gigahertz. It should be understood, however, that any suitable conventionally understood definition or range defining microwave radiation is within the scope and spirit of the present disclosure.

In some exemplary embodiments, the electromagnetic radiation source 40 (and various components thereof) may be spaced from the first interior chamber 14 and the second interior chamber 16 along the vertical direction V. This advantageously provides room in the microwave appliance 10 footprint for inclusion of the second interior chamber 16. Alternatively, however, any suitable positioning and arrangement of the electromagnetic radiation source 40 relative to the chambers 14, 16 is within the scope and spirit of the present disclosure.

As discussed, microwave appliance 10 further includes a chamber configured for thermal heating functions. Accordingly, one or more heating elements, such as a first heating element 50 and a second heating element 52 as shown, may be disposed within the second interior chamber 16. Each heating element 50, 52 may be operable to heat the second interior chamber 16. A heating element as utilized herein is an element that converts electricity from a suitable energy source (such as an electrical outlet) into heat through resistive heating. A heating element in accordance with the present disclosure may, for example, be formed from a suitable metal or ceramic material (or a combination thereof).

In accordance with exemplary embodiments, for example, a heating element such as the first heating element 50 may be positioned adjacent the top surface 30 of the second interior chamber 16. Additionally or alternatively, a heating element such as the second heating element 52 may be positioned adjacent the bottom surface 32 of the second interior chamber 16. Alternatively, any suitable positioning and arrangement of the heating element(s) within the second interior chamber 16 is within the scope and spirit of the present disclosure. For example, heating elements 50, 52 could be positioned adjacent the side surfaces 34, 36, etc.

One or more cooking surfaces may additionally be provided in the second interior chamber 16. In some embodiments, a cooking surface may be a permanent, non-removable cooking surface. Alternatively, however, a cooking surface may be a removable cooking surface 55 as illustrated. Removable cooking surface 55 may for example be a tray as illustrated or a rack. The removable cooking surface 55 may be slidably received into the second interior chamber 16 on rails 57, which may for example be defined in or connected to the side surfaces 34, 36. In exemplary embodiments as shown, a removable cooking surface 55 may be positionable (such as on rails 57) between first and second heating elements 50, 52.

In exemplary embodiments, the volume of the second interior chamber 16 may be less than the volume of the first interior chamber 14, as illustrated. This facilitates efficient heating of and cooking within the second interior chamber 16. Alternatively, however, any suitable sizing of the second interior chamber 16 relative to the first interior chamber 14 is within the scope and spirit of the present disclosure.

Microwave appliance 10 may further include a controller 60 which is configured to operate the electromagnetic radiation source 40 and the heating element(s) 50, 52. The controller may include one or more memory devices and one or more microprocessors, such as general or special purpose microprocessors operable to execute programming instructions or micro-control code associated with electromagnetic radiation source 40 and/or heating element(s) 50, 52 operation. The memory may represent random access memory such as DRAM, or read only memory such as ROM or FLASH. In one embodiment, the processor executes programming instructions stored in memory. The memory may be a separate component from the processor or may be included onboard within the processor.

Controller 60 may generally serve to activate and deactivate the electromagnetic radiation source 40 and the heating element(s) 50, 52 as desired for operation of the microwave appliance 10. Further, microwave appliance 10 may include a user interface panel 62. In one embodiment, the user interface panel 62 may represent a general purpose I/O (“GPIO”) device or functional block. In one embodiment, the user interface 62 may include one or more user inputs 64, such as one or more of a variety of electrical, mechanical or electro-mechanical input devices including rotary dials, push buttons, and touch pads. The user interface panel 62 may additionally include a display component 66, such as a digital or analog display device designed to provide operational feedback to a user. The user interface panel 62, and the user inputs 64 and display component 66 thereof, may be in communication with the controller 60, such as via one or more signal lines or shared communication busses. The user interface panel 62, and the user inputs 64 and display component 66 thereof, may allow a user to select various operational features and modes and monitor progress of the microwave appliance 10 generally. For example, the user inputs 64 allow a user to select the electromagnetic radiation source 40 and/or the heating element(s) 50, 52 for various operations as desired.

In exemplary embodiments, as illustrated in FIGS. 1 through 3, the user interface panel 62 may be spaced from the second interior chamber 16 along the vertical direction V, as illustrated. Further, the user interface panel 62 may be spaced from the first interior chamber 14 along the vertical direction L. Alternatively, any suitable positioning and arrangement of the user interface panel 62 relative to the first interior chamber 14 and the second interior chamber 16 is within the scope and spirit of the present disclosure.

As discussed, both the electromagnetic radiation source 40 and the heating elements 50, 52 receive electrical energy from a suitable power source. In some exemplary embodiments, the power source generates 120 Volt or 240 Volt electricity. In exemplary embodiments, such as when 240 Volt electricity is utilized, the electromagnetic radiation source 40 and the heating elements 50, 52 may be operated simultaneously. In alternative embodiments, such as when 120 Volt electricity is utilized, the electromagnetic radiation source 40 and the heating elements 50, 52 may not be operated simultaneously. In these embodiments, the controller 60 may for example be operable to store input signals corresponding to user inputs for one energy source (i.e. the electromagnetic radiation source 40 or the heating elements 50, 52) during operation of the other energy source, and only activate the other energy source using these signals after the one energy source has finished operation and thus deactivated.

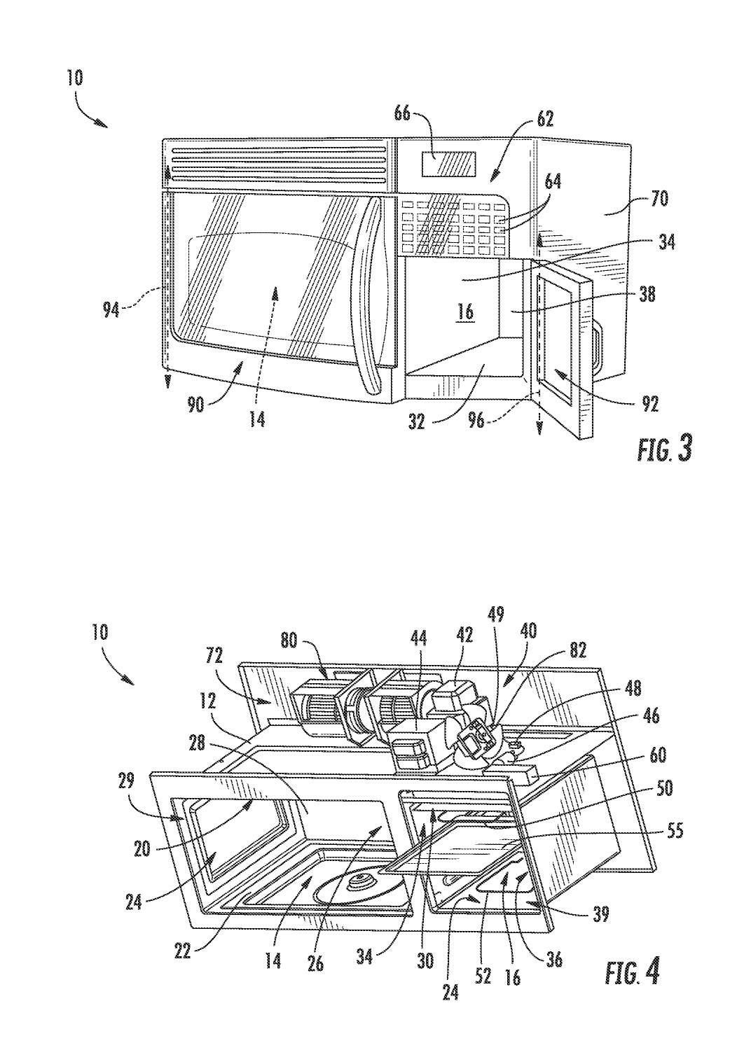

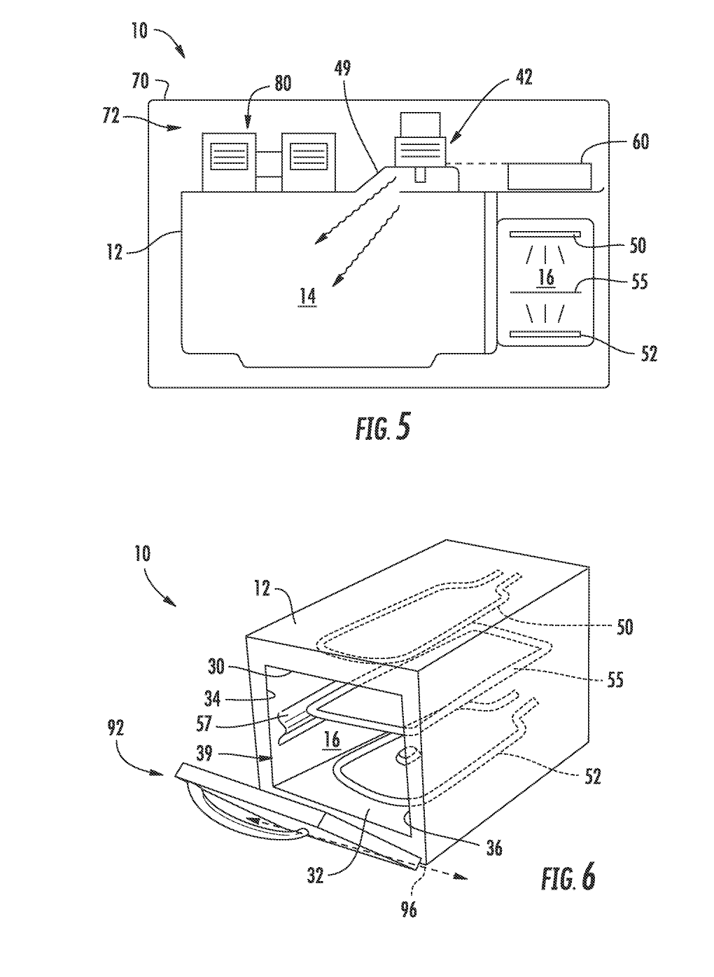

As illustrated in FIGS. 1 through 3 and 5, a microwave appliance 10 in accordance with the present disclosure may further include an outer housing 70. The outer housing 70 may generally surround the casing 12 and defining a passage 72 (see FIGS. 3 and 5) therebetween. In exemplary embodiments, the electromagnetic radiation source 40 may be disposed within the passage 72. Additionally, the controller 60 may be disposed within the passage 72. Further, additional components of the microwave appliance 10 may be disposed within the passage 72. For example, a vent fan 80 and/or cooling fan 82 may be disposed within the passage 72.

As illustrated in FIGS. 1 through 3 and 6, microwave appliance 10 may further include a first door 90 and a second door 92. The doors 90, 92 may generally provide selective access to the first interior chamber 14 and second interior chamber 16, respectively, such as through front openings 29, 39, respectively. In particular, the first door 90 may be rotatable about a first rotational axis 94 to provide selective access to the first interior chamber 14, and second door 92 may be rotatable about a second rotational axis 96 to provide selective access to the second interior chamber 16. Each door may be connected to another component of the microwave appliance 10, such as the casing 12 (as illustrated in FIG. 6 for the second door 92) or the outer housing 70 (as illustrated in FIGS. 1 through 3 for the first door 90 and second door 92).

In exemplary embodiments as illustrated, the first rotational axis 94 is generally parallel to the vertical direction V. Further, in some exemplary embodiments as illustrated in FIGS. 1, 2 and 6, the second rotational axis 96 is generally parallel to the lateral direction L, while in other exemplary embodiments as illustrated in FIG. 3, the second rotational axis 96 is generally parallel to the vertical direction V. Alternatively, any suitable orientation of the rotational axes 94, 96 is within the scope and spirit of the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A microwave appliance, comprising:
a casing defining a first interior chamber and a second interior chamber;
an electromagnetic radiation source coupled to the first interior chamber and operable to provide microwave radiation to the first interior chamber; and
a heating element disposed within the second interior chamber and operable to heat the second interior chamber.

2. The microwave appliance of claim 1, wherein the electromagnetic radiation source comprises a magnetron, a high voltage transformer, a high voltage capacitor and a high voltage diode.

3. The microwave appliance of claim 1, wherein the heating element is a plurality of heating elements.

4. The microwave appliance of claim 3, wherein the plurality of heating elements comprises an first heating element and a second heating element, the first heating element positioned adjacent a top surface defining the second interior chamber, the second heating element positioned adjacent a bottom surface defining the second interior chamber.

5. The microwave appliance of claim 4, further comprising a removable cooking surface positionable between the first heating element and the second heating element.

6. The microwave appliance of claim 1, wherein the microwave appliance defines a vertical direction, a lateral direction, and a transverse direction which are mutually orthogonal, and wherein the second interior chamber is spaced from the first interior chamber along the lateral direction.

7. The microwave appliance of claim 6, wherein the electromagnetic radiation source is spaced from the first interior chamber and the second interior chamber along the vertical direction.

8. The microwave appliance of claim 1, further comprising a controller configured to operate the electromagnetic radiation source and the heating element.

9. The microwave appliance of claim 1, further comprising a user interface panel comprising a plurality of user inputs in communication with the controller.

10. The microwave appliance of claim 9, wherein the microwave appliance defines a vertical direction, a lateral direction, and a transverse direction which are mutually orthogonal, and wherein the user interface panel is spaced from the second interior chamber along the vertical direction.

11. The microwave appliance of claim 10, wherein the user interface panel is spaced from the first interior chamber along the lateral direction.

12. The microwave appliance of claim 1, further comprising an outer housing generally surrounding the casing and defining a passage therebetween.

13. The microwave appliance of claim 12, wherein the electromagnetic radiation source is disposed within the passage.

14. The microwave appliance of claim 1, further comprising a first door rotatable about a first rotational axis to provide selective access to the first interior chamber and a second door rotatable about a second rotational axis to provide selective access to the second interior chamber.

15. The microwave appliance of claim 14, wherein the first rotational axis is generally parallel to the vertical direction and the second rotational axis is generally parallel to the lateral direction.

16. A microwave appliance that defines a vertical direction, a lateral direction, and a transverse direction which are mutually orthogonal, the microwave appliance comprising:
a casing defining a first interior chamber and a second interior chamber;
an outer housing generally surrounding the casing and defining a passage therebetween;
an electromagnetic radiation source coupled to the first interior chamber and operable to provide microwave radiation to the first interior chamber, the electromagnetic radiation source disposed within the passage and spaced from the first interior chamber and the second interior chamber along the vertical direction;
a heating element disposed within the second interior chamber and operable to heat the second interior chamber;
a first door rotatable about a first rotational axis to provide selective access to the first interior chamber; and
a second door rotatable about a second rotational axis to provide selective access to the second interior chamber.

17. The microwave appliance of claim 16, wherein the electromagnetic radiation source comprises a magnetron, a high voltage transformer, a high voltage capacitor and a high voltage diode.

18. The microwave appliance of claim 16, wherein the heating element is a plurality of heating elements.

19. The microwave appliance of claim 16, further comprising a controller configured to operate the electromagnetic radiation source and the heating element.

20. The microwave appliance of claim 16, wherein the first rotational axis is generally parallel to the vertical direction and the second rotational axis is generally parallel to the lateral direction.
